(19) United States
(12) Patent Application Publication
(10) Pub. No.: US 2023/0140775 A1
(43) Pub. Date: May 4, 2023

(54) TPV MADE FROM SILANE GRAFTED PE OR SILANE GRAFTED POE AND A POLYPROPYLENE

(71) Applicant: Cooper-Standard Automotive, Inc., Northville, MI (US)

(72) Inventor: Krishnamachari GOPALAN, Troy, MI (US)

(21) Appl. No.: 17/980,282

(22) Filed: Nov. 3, 2022

Related U.S. Application Data
(60) Provisional application No. 63/275,029, filed on Nov. 3, 2021.

(51) Int. Cl. C08F 255/00; C08F 230/08; C08K 3/30; C08K 5/098; C08L 23/12; C08L 23/16; C08K 3/24; B29C 48/00; B29C 48/40

(52) U.S. Cl. CPC C08F 255/00; C08F 230/085; C08K 3/30; C08K 5/098; C08L 23/12; C08L 23/16; C08K 3/24; B29C 48/022; B29C 48/40; C08K 2003/3045; C08L 2205/03; C08L 2205/025; C08L 2205/22

(57) ABSTRACT

A thermoplastic vulcanizate (TPV) composition includes a dispersed crosslinked phase having residues of a first polymer that includes a first silane grafted polyolefin or residues thereof. The TPV composition also includes a continuous thermoplastic phase having residues of a second polymer component selected from the group consisting of polypropylene resin, polypropylene copolymers and combinations thereof. Characteristically, the dispersed crosslinked phase is dispersed in the continuous thermoplastic phase.

### CROSS-REFERENCE TO RELATED APPLICATIONS

This application claims the benefit of U.S. provisional application Ser. No. 63/275,029 filed Nov. 3, 2021, the disclosure of which is hereby incorporated in its entirety by reference herein.

### TECHNICAL FIELD

In at least one aspect, a TPV composition and method for forming the TPV composition is provided.

### SUMMARY

In at least one aspect, a thermoplastic vulcanizate (TPV) composition is provided. The TPV composition includes a dispersed crosslinked phase having residues of a first polymer component that includes one or more silane-grafted polyolefins. The TPV composition also includes a continuous thermoplastic phase having residues of a second polymer component selected from the group consisting of polypropylene resin, polypropylene copolymers, and combinations thereof. Characteristically, the dispersed crosslinked phase is dispersed in the continuous thermoplastic phase. The composition also includes residues of an inorganic hydrate.

In another aspect, a method for making a thermoplastic vulcanizate composition is provided. The method includes steps of providing a first polymer that includes one or more silane grafted polyolefins and providing a second polymer component selected from the group consisting of polypropylene resin, polypropylene copolymers, and combinations thereof. The first polymer component, the second polymer component, and crosslinking additives are combined to form a reactive mixture. Advantageously, the crosslinking agents include an inorganic hydrate as a source of water for crosslinking. The reactive mixture is heated to form the thermoplastic vulcanizate composition. Characteristically, a crosslinked phase including residues of the first polymer component is dispersed in a continuous thermoplastic phase including residues of the second polymer component.

In another aspect, a method for making a thermoplastic vulcanizate composition is provided. The method includes steps of providing a first polymer that includes one or more silane grafted polyolefins. Characteristically, the silane-grafted polyolefin is formed in an extruder. A second polymer component selected from the group consisting of polypropylene resin, polypropylene copolymers, and combinations thereof is provided to (i.e., introduced into) the same extruder. The first polymer component, the second polymer component, and crosslinking additives are combined in the same extruder to form a reactive mixture. Advantageously, the crosslinking agents include an inorganic hydrate as a source of water for crosslinking. The reactive mixture is heated to form the thermoplastic vulcanizate composition. Characteristically, a crosslinked phase including residues of the first polymer component is dispersed in a continuous thermoplastic phase including residues of the second polymer component.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Schematic of a twin-screw extruder that can be used to form a TPV composition.

FIG. 2. Cure curves for silane-grafted polyolefins for various catalyst systems.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alylaryl (e.g., C₁₋₈ alkyl C₆₋₁₀ aryl), —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺is a metal ion, and L⁻is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁺, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R″' are C₁₋₁₀ alkyl or C₆₋₁₈ aryl groups, M⁺is a metal ion, and L⁻ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e., the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . . 97, 98, 99, 100. Similarly, when any range is called for, intervening numbers that are increments of the difference between the upper limit and the lower limit divided by 10 can be taken as alternative upper or lower limits. For example, if the range is 1.1 to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

The term “metal” as used herein means an alkali metal, an alkaline earth metal, a transition metal, a lanthanide, an actinide, or a post-transition metal.

The term “residue” means a portion, and typically a major portion, of a molecular entity, such as a molecule or a part of a molecule such as a group, which has undergone a chemical reaction and is now covalently linked to another molecular entity. In a refinement, the term “residue” means an organic structure that is incorporated into the polymer by polycondensation or ring-opening polymerization reaction involving the corresponding monomer. In another refinement, the term “residue” when used in reference to a monomer or monomer unit means the remainder of the monomer unit after the monomer unit has been incorporated into the polymer chain. When a polymer component or a portion thereof does not react when included in a combination, the residue is the unreacted polymer component in reference to the combination.

The term “extended oil” refers to synthetic oil or mineral oil used to impart flexibility to rubber, elastomer, or the like.

Throughout this application, where publications are referenced, the disclosures of these publications in their entireties are hereby incorporated by reference into this application to more fully describe the state of the art to which this invention pertains.

Abbreviations:

“DOTL” means dioctyl tin dilaurate catalyst.

“MB” means masterbatch.

“MFI” means melt flow index.

“TPV” means thermoplastic vulcanizate.

In an embodiment, a thermoplastic vulcanizate (TPV) composition is provided. The TPV composition includes a crosslinked dispersed phase comprising residues of a first polymer component that includes a first silane grafted polyolefin. The thermoplastic vulcanizate (TPV) composition further includes a continuous thermoplastic phase comprising a second polymer component selected from the group consisting of polypropylene resin, polypropylene copolymers, and combinations thereof and/or residues thereof. Characteristically, the crosslinked dispersed phase is dispersed in the continuous thermoplastic phase. Typically, the dispersed crosslinked phase is present in an amount of about 20 to 85 wt % of the combined weight of the crosslinked dispersed phase and the continuous thermoplastic phase; and the continuous thermoplastic is present in an amount from about 80 to 15 wt % of the combined weight of the crosslinked dispersed phase and the continuous thermoplastic phase. In a refinement, the dispersed crosslinked phase is present in an amount of about 30 to 70 wt % of the combined weight of the crosslinked dispersed phase and the continuous thermoplastic phase; and the continuous thermoplastic is present in an amount from about 70 to 30 wt % of the combined weight of the crosslinked dispersed phase and the continuous thermoplastic phase.

Advantageously, the TPV composition set forth herein possesses a low compression set, softness, resilience, and rubber-like behavior. Moreover, the TPV composition exhibits thermoplastic flow behavior useful for injection molding, compression molding, and extrusion molding. In this regard, the continuous phase provides flowability and behaves like a thermoplastic for injection molding or extrusion. The crosslinked phase provides elastic properties.

In a variation, the first polymer component further includes one or more additional elastomers or resins. Examples of such additional elastomers or resins include, but are not limited to, polyolefin elastomers, ethylene propylene diene monomer rubbers, and mixtures thereof. In a refinement, the additional elastomers or resins include can be a polyolefin elastomer including an olefin block copolymer, an ethylene α-olefin copolymer, a propylene α-olefin copolymer, isotactic propylene units with random ethylene distributions, polyolefin elastomer/ethylene-octene copolymer, styrene ethylene butylene styrene copolymer, EPDM, EPM, or a mixture of two or more of any of these materials.

In a variation, the TPV composition includes one or more or any combination of or all of the following components: oil (e.g., extended oils), plasticizer, fillers, crosslinking additives, coagents, and/or residues thereof. In a refinement, the coagents are selected from the group consisting of triallyl cyanurate, trimethyl, propane triacrylate, N,N-m-phenylene dimaleimide, m-phenylene dimaleimide, and combinations thereof. In a refinement, the crosslinking agents can include an inorganic hydrate as a source of water for crosslinking. In another refinement, the crosslinking additives include a component selected from the group consisting of water, a peroxide, boric acid, sulfonic acid, and combinations thereof. In another refinement, the antioxidants are selected from the group consisting of phenols, organic phosphates, thioethers, and blends thereof.

In some variations, the TPV composition includes residues of an inorganic hydrate. Examples of such inorganic hydrates include calcium sulfate dihydrate calcium sulfate and hemihydrate (i.e., plaster of Paris). As set forth below, inorganic hydrates can liberate water during extrusion for crosslinking.

In a variation, the TPV composition can further include residues of a condensation catalyst. In a refinement, the condensation catalyst is a bismuth carboxylate. In a further refinement, the condensation catalyst is a hydrolytically stabilized bismuth carboxylate. In a refinement, such hydrolytically stabilized bismuth carboxylates have a hydrocarbon chain of 11-36 carbons. In a further refinement, such hydrolytically stabilized bismuth carboxylates have a molecular weight in the range of 165-465. Additional details of hydrolytically stabilized bismuth carboxylates are provided in U.S. Pat. No. 6,353,057; the entire disclosure of which is hereby incorporated by reference. Additional examples of condensation catalysts include boric acid, sulfonic acid, dioctytin dilaurate.

In a refinement, the TPV composition can include a first silane grafted polyolefin and a second silane grafted polyolefin. In a further refinement, the TPV composition can include one or more silane grafted polyolefins in addition to the silane grafted polyolefins and a second silane grafted polyolefin. It should be appreciated that each of these examples for the first silane-grafted polyolefin and the second silane-grafted polyolefin are formed from base polyolefin or polymer not having the silane grafting.

In a variation, the first polymer component includes one or more silane-grafted polyolefin components. Silane grafting is facilitated by combining a silane mixture combined with one or more polyolefins. In a refinement, the one or more silane-grafted polyolefin components independently include silane functional groups grafted onto one or more polyolefins. Suitable silane functional groups are described by formula I:

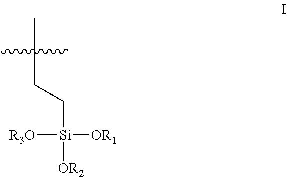

wherein R₁, R₂, and R₃ are each independently H or C₁₋₈ alkyl. In a refinement, R₁, R₂, and R₃ are each independently, methyl, ethyl, propyl, or butyl. Typically, the silane-grafted polyolefin component is formed from the requisite polyolefins prior to combining with the masterbatch (Component B) as set forth below in more detail.

In one refinement, the one or more silane-grafted polyolefin components include a first silane-grafted polyolefin and a second silane-grafted polyolefin, and optionally one or more additional silane grafted polyolefins. In a variation, the first silane-grafted polyolefin has a first melt index of less than about 5, while the second silane-grafted polyolefin has a second melt index greater than about 20. In another aspect, the first silane-grafted polyolefin has a higher weight average molecular weight than the second silane-grafted polyolefin.

In a variation, the one or more silane-grafted polyolefin components is selected from the group consisting of silane-grafted ethylene α-olefin copolymers, silane-grafted polyolefin elastomer (POE), silane-grafted olefin block copolymers, and combinations thereof. Each of these silane-grafted ethylene α-olefin copolymers, silane-grafted polyolefin elastomer (POE), silane-grafted olefin block copolymers may be formed using at least one base polyolefin n as set forth below in more detail.

In other refinements, the first silane-grafted polyolefin and/or the second silane-grafted polyolefin (and/or any additional silane-grafted polymers in polymer-enhancing composition) is selected from the group consisting of silane-grafted olefin homopolymers, blends of silane-grafted homopolymers, silane-grafted copolymers of two or more olefins, blends of silane-grafted copolymers of two or more olefins, and a combination of silane-grafted olefin homopolymers blended with silane-grafted copolymers of two or more olefins.

In still other refinements, the first silane-grafted polyolefin and/or the second silane-grafted polyolefin (and/or any additional silane-grafted polymers in polymer-enhancing composition) are each independently a silane-grafted homopolymer or silane-grafted copolymer of an olefin selected from the group consisting of ethylene, propylene, 1-butene, 1-propene, 1-hexene, 1-octene, C₉₋₁₆ olefins, and combinations thereof.

In another refinement, the first silane-grafted polyolefin and/or the second silane-grafted polyolefin (and/or any additional silane-grafted polymers in the polymer-enhancing composition) independently include a polymer selected from the group consisting of silane-grafted block copolymers, silane-grafted ethylene propylene diene monomer polymers, silane-grafted ethylene octene copolymers, silane-grafted ethylene butene copolymers, silane-grafted ethylene α-olefin copolymers, silane-grafted 1-butene polymer with ethene, silane-grafted polypropylene homopolymers, silane-grafted methacrylate-butadiene-styrene polymers, silane-grafted polymers with isotactic propylene units with random ethylene distribution, silane-grafted styrenic block copolymers, silane-grafted styrene ethylene butylene styrene copolymer, and combinations thereof.

In another refinement, the first and/or second silane-grafted polyolefin is selected from the group consisting of silane-grafted olefin homopolymers, blends of silane-grafted homopolymers, silane-grafted copolymer of two or more olefins, blends of silane-grafted copolymers of two or more olefins, and blends of silane-grafted olefin homopolymers with silane-grafted copolymers of two or more olefins.

In still another refinement, the first and/or second silane-grafted polyolefin is a silane grafted homopolymer or copolymer of an olefin is selected from the group consisting of ethylene, propylene, 1-butene, 1-propene, 1-hexene, 1-octene, and C₉₋₁₆ olefins.

It should be appreciated that each of these examples for the first silane-grafted polyolefin and the second silane-grafted polyolefin are formed from base polyolefin or polymer not having the silane grafting. In some variations, as set forth above, the thermoplastic vulcanizate (TPV) composition includes one or more silane-grafted polyolefin components. The silane-grafted polyolefin component is formed by silane grafting at least one base polyolefin. Silane grafting is achieved by combining a silane mixture combined with one or more polyolefins. The silane mixture may include one or more silanes, oils, peroxides, antioxidants, catalysts, and/or other components such as a grafting initiator. The synthesis of the silane-grafted polyolefin component may be performed as described in the grafting steps outlined using the single-step Monosil process or the two-step Sioplas process as disclosed in U.S. Patent Publication 2018/0160767, which is herein incorporated by reference in its entirety. In a refinement, the silane is a vinyl alkoxy silane having the following formula:

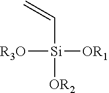

wherein R₁, R₂, and R₃ are each independently H or C₁₋₈ alkyl. Example silanes include, but are not limited to vinyl trimethoxy silanes, vinyl triethoxy silanes, and vinyl tripropoxy silanes. Therefore, the one or more silane-grafted polyolefin components independently include silane functional groups grafted thereon having formula I:

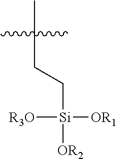

wherein R₁, R₂, and R₃ are each independently H or C₁₋₈ alkyl. In a refinement, R₁, R₂, and R₃ are each independently methyl, ethyl, propyl, or butyl. When the first polymer component includes a plurality of silane-grafted polyolefins, a mixture of base polyolefins can be formed and then silane grafted. Alternatively, the polyolefins can be individually silane grafted and then combined.

The base polyolefin or polymer is silane grafted in a grafting step that includes initiation from a grafting initiator followed by propagation and chain transfer with one or more polyolefins. The grafting initiator, in some aspects, a peroxide or azo compound, homolytically cleaves to form two radical initiator fragments that transfer to one of the first and second polyolefins chains through a propagation step. The free radical, now positioned on the first or second polyolefin chain, can then transfer to a silane molecule and/or another polyolefin chain. Once the initiator and free radicals are consumed, the silane grafting reaction for the first and second polyolefins is complete.

In some aspects, the base polyolefin is a copolymer of an olefin selected from the group consisting of ethylene, propylene, 1-butene, 1-propene, 1-hexene, 1-octene, C₉₋₂₀ olefins, and combinations thereof. Examples of comonomers include but are not limited to aliphatic C₂₋₂₀ α-olefins. Examples of suitable aliphatic C₂₋₂₀ α-olefins include ethylene, propylene, 1-butene, 4-methyl-1-pentene, 1-hexene, 1-octene, 1-decene, 1-dodecene, 1-tetradecene, 1-hexadecene, 1-octadecene and 1-eicosene. In a refinement, the comonomer is vinyl acetate. The amount of comonomer can, in some embodiments, be from greater than 0 wt % to about 12 wt % based on the weight of the polyolefin, including from greater than 0 wt % to about 9 wt %, and from greater than 0 wt % to about 7 wt %. In some embodiments, the comonomer content is greater than about 2 mol % of the final polymer, including greater than about 3 mol % and greater than about 6 mol %. The comonomer content may be less than or equal to about 30 mol %. A copolymer can be a random or block (heterophasic) copolymer. In some embodiments, the polyolefin is a random copolymer of propylene and ethylene.

In some aspects, the base polyolefins is selected from the group consisting of an olefin homopolymer, a blend of homopolymers, a copolymer made using two or more olefins, a blend of copolymers each made using two or more olefins, and a combination of olefin homopolymers blended with copolymers made using two or more olefins. The olefin may be selected from ethylene, propylene, 1-butene, 1-propene, 1-hexene, 1-octene, and other higher 1-olefin. In some aspects, the polyethylene used for the at least one polyolefin can be classified into several types including, but not limited to, LDPE (Low Density Polyethylene), LLDPE (Linear Low Density Polyethylene), and HDPE (High Density Polyethylene). In other aspects, the polyethylene can be classified as Ultra High Molecular Weight (UHMW), High Molecular Weight (HMW), Medium Molecular Weight (MMW) and Low Molecular Weight (LMW). In still other aspects, the polyethylene may be an ultra-low density ethylene elastomer.

In a variation, the base polyolefin component is selected from the group consisting of ethylene α-olefin copolymers, polyolefin elastomer (POE), olefin block copolymers, and combinations thereof.

In other refinements, the base polyolefin is selected from the group consisting of olefin homopolymers, blends of homopolymers, copolymers of two or more olefins, blends of copolymers of two or more olefins, and a combination of olefin homopolymers blended with copolymers of two or more olefins.

In another refinement, the base polyolefin includes a polymer selected from the group consisting of block copolymers, ethylene propylene diene monomer polymers, ethylene octene copolymers, ethylene butene copolymers, ethylene α-olefin copolymers, 1-butene polymer with ethene, polypropylene homopolymers, methacrylate-butadiene-styrene polymers, silane-grafted polymers with isotactic propylene units with random ethylene distribution, styrenic block copolymers, styrene ethylene butylene styrene copolymer, and combinations thereof.

The one or more base polyolefins can be a polyolefin elastomer including an olefin block copolymer, an ethylene α-olefin copolymer, a propylene α-olefin copolymer, isotactic propylene units with random ethylene distributions, polyolefin elastomer/ethylene-octene copolymer, styrene ethylene butylene styrene copolymer, EPDM, EPM, or a mixture of two or more of any of these materials. Specific examples for the base polyolefins are as follows. Exemplary olefin block copolymers include those sold under the trade names INFUSE™ (e.g., INFUSE 9807, INFUSE 9817, INFUSE 9900, AND INFUSE 9107) commercially available from (the Dow Chemical Company) and SEPTON™ V-SERIES (e.g., SEPTON V 9641), a styrene-ethylene-butylene-styrene block copolymer available from Kuraray Co., LTD.

In some variations, the foamed silane-crosslinked polyolefin elastomer may include one or more oils, and in particular, paraffin oil. Non-limiting types of oils include white mineral oils and naphthenic oils. In some embodiments, the oil(s) are present in an amount of from about 0 wt % (or 0.1 wt %) to about 10 wt %.

In another embodiment, a method for making a TPV composition is provided. The method includes steps of providing a first polymer that includes a first silane grafted polyolefin and providing a second polymer component selected from the group consisting of polypropylene resin, polypropylene copolymers, and combinations thereof. The first polymer component, the second polymer component, and crosslinking additives are combined to form a reactive mixture. The reaction mixture is heated to form the TPV composition. Characteristically, a crosslinked phase including residues of the first polymer component is dispersed in a continuous thermoplastic phase including residues of the second polymer component.

In a variation, the first polymer component further includes one or more additional elastomers or resins. In a refinement, the one or more additional elastomers or resins include a component selected from the group consisting of polyolefin elastomers, ethylene propylene diene monomer rubbers, and mixtures thereof.

Crosslinking of the dispersed phase is accomplished by the crosslinking additives, which can be supplied as a crosslinking package. In a refinement, the crosslinking additives include a component selected from the group consisting of water, a peroxide, a condensation catalyst, and combinations thereof. Advantageously, the crosslinking agents include an inorganic hydrate as a source of water for crosslinking. In one refinement, the inorganic hydrate include calcium sulfate dihydrate as a source of water for crosslinking during extrusion since it is difficult to add water to an extruder. In another refinement, the condensation catalyst is boric acid, sulfonic acid, or mixtures thereof.

In a refinement, the peroxide includes a peroxide component selected from the group consisting of hydrogen peroxide, alkyl hydroperoxides, dialkyl peroxides, and diacyl peroxides. Examples for the peroxide include, but are not limited to, an organic peroxide selected from the group consisting of di(tert-butylperoxyisopropyl) benzene, di-t-butyl peroxide, t-butyl cumyl peroxide, dicumyl peroxide, 2,5-dimethyl-2,5-di(t-butyl-peroxy)hexyne-3, 1,3-bis(t-butyl-peroxy-isopropyl) benzene, n-butyl-4,4-bis(t-butyl-peroxy)valerate, benzoyl peroxide, t-butylperoxybenzoate, t-butylperoxy isopropyl carbonate, t-butylperbenzoate, bis(2-methylbenzoyl)peroxide, bis(4-methylbenzoyl) peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α, α′-bis(t-butylpexoxy)-1,4-diisopropylbenzene, 2,5-bis(t-butylperoxy)-2,5-dimethylhexane, 2,5-bis(t-butylperoxy)-2,5-dimethyl-3-hexyne, 2,4-dichlorobenzoyl peroxide, and combinations thereof.

In some variations, the condensation catalyst can include, for example, organic bases, carboxylic acids, inorganic acids, organic sulfonic acids, and organometallic compounds (e.g., organic titanates and complexes or carboxylates of lead, cobalt, iron, nickel, zinc, and tin). In other aspects, the condensation catalyst can include fatty acids and metal complex compounds such as metal carboxylates; aluminum triacetyl acetonate, iron triacetyl acetonate, manganese tetraacetyl acetonate, nickel tetraacetyl acetonate, chromium hexaacetyl acetonate, titanium tetraacetyl acetonate and cobalt tetraacetyl acetonate; metal alkoxides such as aluminum ethoxide, aluminum propoxide, aluminum butoxide, titanium ethoxide, titanium propoxide and titanium butoxide; metal salt compounds such as sodium acetate, tin octylate, lead octylate, cobalt octylate, zinc octylate, calcium octylate, lead naphthenate, cobalt naphthenate, dibutyltin dioctoate, dibutyltin dilaurate, dibutyltin maleate and dibutyltin di(2-ethylhexanoate); acidic compounds such as formic acid, acetic acid, propionic acid, p-toluenesulfonic acid, trichloroacetic acid, phosphoric acid, monoalkylphosphoric acid, dialkylphosphoric acid, phosphate ester of p-hydroxyethyl (meth)acrylate, monoalkylphosphorous acid and dialkylphosphorous acid; acids such as p-toluenesulfonic acid, phthalic anhydride, benzoic acid, benzenesulfonic acid, dodecylbenzenesulfonic acid, formic acid, acetic acid, itaconic acid, oxalic acid and maleic acid, ammonium salts, lower amine salts or polyvalent metal salts of these acids, sodium hydroxide, lithium chloride; organometal compounds such as diethyl zinc and tetra(n-butoxy) titanium; and amines such as dicyclohexylamine, triethylamine, N,N-dimethylbenzylamine, N,N,N′,N′-tetramethyl-1,3-butanediamine, diethanolamine, triethanolamine and cyclohexylethylamine. In still other aspects, the condensation catalyst can include ibutyltindilaurate, dioctyltinmaleate, dibutyltindiacetate, dibutyltindioctoate, stannous acetate, stannous octoate, lead naphthenate, zinc caprylate, and cobalt naphthenate. Depending on the desired final material properties of the dispersed crosslinked phase, a single condensation catalyst or a mixture of condensation catalysts may be utilized. The catalyst(s) may be present in an amount of from about 0.01 wt % to about 1.0 wt %, including from about 0.25 wt % to about 8 wt %, based on the total weight of the dispersed crosslinked phase.

In some variations, the reactive mixture further includes a component selected from the group consisting of an oil (e.g., extended oil), plasticizer, a filler, coagents, antioxidants, and combinations thereof.

As set forth above, the silane grafted polyolefins is prepared by combining a base polyolefin, a silane composition, a catalyst, and a grafting initiator to form a grafting composition. Characteristically, the silane composition, includes a vinyl alkoxy silane having the following formula:

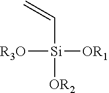

wherein R₁, R₂, and R₃ are each independently H or C₁₋₈ alkyl. In a refinement, the grafting composition is introduced into a twin screw extruder at a first feed location and reacted at a temperature above 180° C. In a further refinement, the second polymer component is introduced into the twin screw extruder at a second feed location that is downstream of the first feed location.

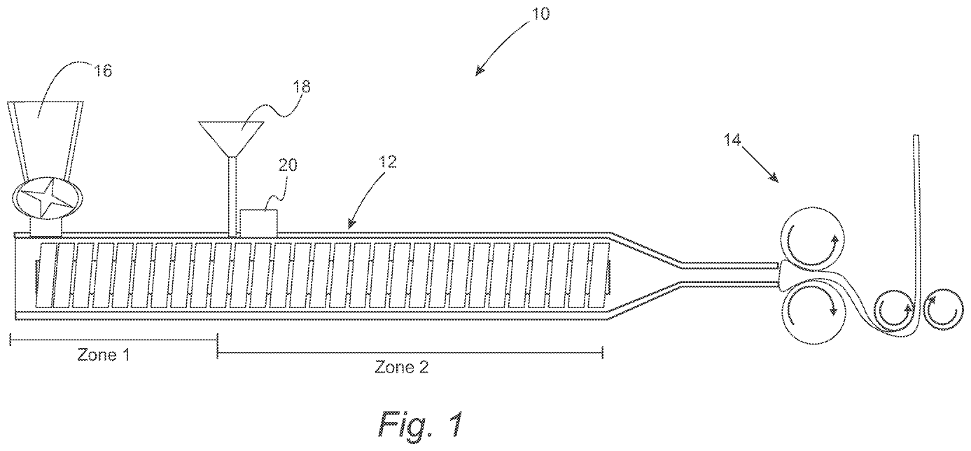

Referring to FIG. 1, a method for preparing the first polymer component that includes a silane grafted polyolefins is provided. Twin-screw extruder 10 includes chamber, container, or barrel 12. The inside of the chamber, container, or barrel 12 includes a set of screws (not depicted) processing the components and forming the non-crosslinked elastomeric material. The mixed material proceeds to a calender 14 having two or more rollers. The number of rollers can be 2, 3, 4, or a different number. The calendaring process forms the mixed material into a tape or a sheet. In one example, a base polyolefin is introduced into a twin-screw extruder 10 through the first material feeder 16 according to the recipes set forth herein and placed into a uniform melt. The mixture is melted and mixed in a twin-screw-extruder 10 at a presetting temperature from 200° C. to 220° C., and screw speeds are from 500 rpm to 900 rpm. An organosilane is injected into a twin-screw at end of melting zone (Zone 1) according to the recipes set forth herein. The second polymer component (e.g., polypropylene) and the crosslinking package are added to the beginning of Zone 2 via material feeder 18. The filler (e.g., calcium carbonate is added into the twin-screw extruder by side stuff feeder 20 according to recipe. The oil (e.g., extended oil) is injected into the twin-screw extruder at 2nd injection site according to the recipe. The TPV composition extruded from twin-screw extruder is pelletized into pellets.

In another example, an alternative method for preparing the first polymer component that includes silane grafted polyolefins, silane grafted polyolefin elastomers, silane grafted ethylene propylene diene monomer rubbers, or mixtures thereof is provided. Premixed dry silane, catalyst, initiator, POE are added into twin screw extruder 10 by a feeder 16. The ingredients are mixed and melted in the twin-screw extruder 10. The POE is grafted with silane at a temperature above 180° C. (e.g., 200 C -220 C) at a screw speed from 500 to 900 rpm. The second polymer component (e.g., polypropylene) and the crosslinking package are added at the beginning of Zone 2. The filler is introduced into the twin-screw extruder by side stuff feeder 20 according to the recipes set forth herein. The oil (e.g., extended oil) is injected into the twin-screw extruder at 2nd injection site. The TPV composition extruded from the twin-screw extruder is pelletized into pellets.

In another example, silane grafted POE or PE is used as an ingredient in TPV recipe. The ingredients are weighed according to recipes and mixed in a dry mixer. The mixture is then added to extruder 10 with a Loss-in-Weight feeder at 4-8 kgs/hours. The mixture is melted and mixed in a twin-screw extruder at the presetting temperature at 200° C. to 220° C., and screw speeds are from 500 rpm-900 rpm. The extrudate is cooled in a water tank at 65-80 F. The extrudate is cut into pellets by a pelletizer.

In a batch method, the ingredients are weighted according to recipes. The second polymer component is added to a Banbury mixer at 200 C, mixed and uniformly melted. The silane grafted POE is added to Banbury mixer at 200 C while mixing the material uniformly. The crosslinking package and other additives are added and mixed for a predetermined time period. The resulting product is discharged from the mixer, processed in any desired way (e.g., on roll mill), cooled, and pelletized.

The following examples illustrate the various embodiments of the present invention. Those skilled in the art will recognize many variations that are within the spirit of the present invention and the scope of the claims.

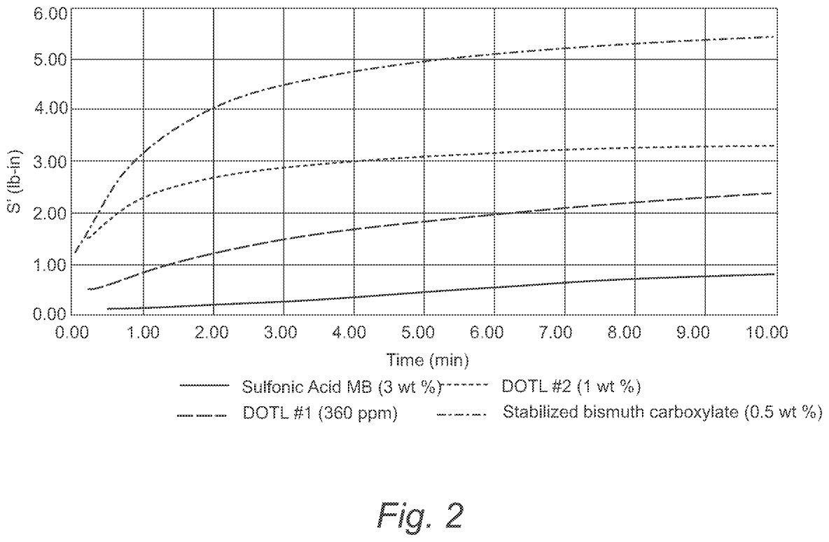

FIG. 2 provides cure curves at 200° C. for compositions that include a silane-grafted polyolefin, Plaster of Paris (calcium sulfate hemihydrate), and various catalysts. The figure plots torque as a function of time. Clearly, the hydrolytically stabilized bismuth carboxylate provided the fastest cure rate.

Table 1 provides Examples 1-4 of a TPV composition formed from a silane grafted polyolefin in a twin-screw extruder. It should be appreciated that TPV compositions can be made using ingredients within plus and minus 30 percent of the values indicated in Table 1. Table 2 provides measured physical properties of the TPV compositions in Table 1.

TABLE 1
Twin screw extruder TPV compositions

| Examples | 1 | 2 | 3 | 4 |
|---|---|---|---|---|
| Processing method | Twin screw | Twin screw | Twin screw | Twin screw |
| | extruder | extruder | extruder | extruder |
| silane grafted polyolefin. a | 69.44% | 49.49% | 34.59% | 67.31% |
| first polymer | | | | |
| oil extended EPDM | 0.00% | 19.79% | 34.59% | 0.00% |
| polypropylene | 29.76% | 29.69% | 29.65% | 28.85% |
| boric acid (catalyst) | 0.50% | 0.30% | 0.20% | 0.48% |
| triallyl isocyanurate | 0.00% | 0.12% | 0.18% | 0.00% |
| Peroxide | 0.00% | 0.32% | 0.49% | 0.00% |
| calcium sulfate hemihydrate, | 0.00% | 0.00% | 0.00% | 2.88% |
| monobutyl tin | 0.00% | 0.00% | 0.00% | 0.19% |
| hydroxychloride | | | | |
| anti oxident | 0.30% | 0.30% | 0.30% | 0.29% |
| extended oil | | | | |
| filler | | | | |
| | 100% | 100% | 100% | 100% |

TABLE 2
Physical properties of the compositions in Table 1.

| Examples | | 1 | 2 | 3 | 4 |
|---|---|---|---|---|---|
| Hardness | shore A | 90 | 85 | 82 | 89 |
| Compression set, | % | 45.30% | 44.80% | 36.40% | 50.40% |
| 22 h/70 C. | | | | | |
| Compression set, | % | 50.40% | 44.40% | 45.70% | 48.20% |
| 22 h/90 C. | | | | | |
| MFI | g/10 min | 11.2 | 21.2 | 66.1 | 1.7 |
| melt density | g/cc | 0.8 | 0.85 | 0.87 | 0.78 |
| Visicosity, @ | cp | 33.56 | 37.18 | 30.98 | 38.5 |
| 10000 | | | | | |
| Tensile strength | MPa | 12.0 | 8.9 | 6.6 | 10.1 |
| elongation | % | 467.6 | 436.0 | 356.0 | 372.1 |
| Tear strength | N | 47.4 | 35.8 | 32.7 | 44.6 |

Table 3 provides Examples 6-7 of a TPV composition formed from a silane grafted polyolefin in a batch reactor. It should be appreciated that TPV compositions can be made using ingredients within plus and minus 30 percent of the values indicated in Table 3. Table 4 provides measured physical properties of the TPV compositions in Table 3.

TABLE 3
Batch reactor TPV compositions,

| Examples | 6 | 7 |
|---|---|---|
| Processing method | Batch | Batch |
| Raw materials | | |
| First Polypropylene | 26.95% | 26.87% |
| Second Polypropylene | 4.99% | 4.98% |
| silane grafted polyolefin | 59.88% | 59.70% |
| calcium sulfate hemihydrate, | 3.99% | 3.98% |
| Tin catalyst | 3.99% | 3.98% |
| Peroxider master batch | 0.00% | 0.00% |
| Peroxide for crosslinking | 0.00% | 0.00% |
| antioxidant | 0.00% | 0.00% |
| boric acid (catalyst) | 0.20% | 0.50% |
| | 100% | 100% |

TABLE 4
Physical properties of the compositions in Table 3.

| | | 6 | 7 |
|---|---|---|---|
| Hardness | shore A | 64.6 | 65 |
| Compression set, 22 h/70 C. | | 56.00% | 55.4% |
| Compression set, 22 h/90 C. | | 76.00% | 67.2% |
| Visicosity, cp @ 10000 1/s | cp | 32 | 32.5 |
| Tensile strength | MPa | 12.5 | 12.5 |
| elongation | % | 357.0 | 257 |

Tables 5a and 5b provide Examples 8-16 of a TPV composition formed from a silane grafted polyolefin in a twin-screw extruder. It should be appreciated that TPV compositions can be made using ingredients within plus and minus 30 percent of the values indicated in Tables 5a and 5b. Table 6 provides measured physical properties of the TPV compositions in Table 1.

TABLE 5a
Twin screw extruder TPV compositions

| Example | 8 | 9 | 10 | 11 | 12 |
|---|---|---|---|---|---|
| Processing method* | TSE | TSE | TSE | TSE | TSE |
| Olefin Block Copolymers with | 34.41% | 34.41% | 35.46% | 35.39% | 35.46% |
| MFI of 15 g/10 min, density of | | | | | |
| 0.877 | | | | | |
| Olefin Block Copolymers with | 34.41% | 34.41% | 35.46% | 35.39% | 35.46% |
| MFI of 15 g/10 min, density of | | | | | |
| 0.866. | | | | | |
| Olefin Block Copolymers with | | | | | |
| MFI of 30 g/10 min, density of | | | | | |
| 0.880 | | | | | |
| 50% polysiloxane MB in PP. | 9.18% | 9.18% | 9.46% | 9.44% | 9.46% |
| silane cocktail from | 0.92% | 0.92% | 0.95% | 0.94% | 0.95% |
| polyolefin elastomer | | | | | |
| PP with 125 MFI HK 060 (125 | 12.88% | | 13.27% | 13.24% | |
| MFI) | | | | | |
| PP with 75 MFI | | 12.88% | | | 13.27% |
| paraffinic oil | | | | | |
| DOTL-based tin catalyst | 3.00% | 3.00% | 5.00% | 5.00% | 5.00% |
| calcium sulfate dihydrate | 5.00% | 5.00% | | | |
| Boric acid | | | 0.20% | 0.40% | 0.20% |
| Al(OH)3 | | | | | |
| | 100% | 100% | 100% | 100% | 100% |

*TSE = twin screw extruder

TABLE 5b
Twin screw extruder TPV compositions

| Example | 13 | 14 | 15 | 16 |
|---|---|---|---|---|
| Processing method* | TSE | TSE | TSE | TSE |
| Olefin Block Copolymers with MFI | 35.46% | 34.41% | 0.00% | 0.00% |
| of 15 g/10 min, density of 0.877 | | | | |
| Olefin Block Copolymers with MFI | 35.46% | 34.41% | 35.48% | 34.79% |
| of 15 g/10 min, density of 0.866. | | | | |
| Olefin Block Copolymers with MFI | | | 35.48% | 34.79% |
| of 30 g/10 min, density of 0.880 | | | | |
| 50% polysiloxane MB in PP. | 9.46% | 9.18% | 9.46% | 10.71% |
| silane cocktail from | 0.95% | 0.92% | 0.95% | 1.07% |
| polyolefin elastomer | 6.63% | | 6.62% | |
| PP with 125 MFI HK 060 (125 MFI) | 6.64% | | 6.62% | 13.24% |
| PP with 75 MFI | | 12.88% | | |
| paraffinic oil | | | | |
| DOTL-based tin catalyst | 5.00% | 3.00% | 5.00% | 5.00% |
| calcium sulfate dihydrate | | | | |
| Boric acid | 0.20% | | 0.20% | 0.20% |
| Al(OH)3 | | 5.00% | | |
| | 100% | 100% | 100% | 100% |

*TSE = twin screw extruder

TABLE 6
Physical properties of the compositions in Table 5a and 5b.

| Hardness | 88 | 87 | 88 | 87 | 87 | 84 | 88 | 85 | 92 |
|---|---|---|---|---|---|---|---|---|---|
| Tensile | 5.99 | 5.62 | 6.00 | 5.76 | 5.80 | 5.34 | 6.23 | 5.71 | 7.26 |
| 100% M | 4.36 | 4.10 | 4.47 | 4.29 | 4.19 | 4.05 | 4.40 | 4.08 | 5.15 |
| Elongation | 371 | 331 | 372 | 345 | 385 | 336 | 303 | 374 | 428 |
| Tear | 39.76 | 39.38 | 47.52 | 42.10 | 43.43 | 41.21 | 42.37 | 43.08 | 52.72 |
| C-set, | 53.2 | 52.4 | 36 | 53.6 | 55.5 | 31.1 | 46.1 | 62.1 | 71.4 |
| 22 hr/70 C. | | | | | | | | | |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A thermoplastic vulcanizate (TPV) composition comprising:
a dispersed crosslinked phase comprising residues of a first polymer component that includes a first silane grafted polyolefin;
a continuous thermoplastic phase comprising residues of a second polymer component selected from the group consisting of polypropylene resin, polypropylene copolymers, and combinations thereof and/or residues thereof, wherein the dispersed crosslinked phase is dispersed in the continuous thermoplastic phase; and
residues of an inorganic hydrate.

2. The composition of claim 1, wherein the inorganic hydrate is calcium sulfate hemihydrate or calcium sulfate dihydrate.

3. The composition of claim 1, further comprising residues of a condensation catalyst.

4. The composition of claim 3, wherein the condensation catalyst is bismuth carboxylate.

5. The composition of claim 3, wherein the condensation catalyst is a hydrolytically stabilized bismuth carboxylate.

6. The composition of claim 1, wherein the first polymer component further includes one or more additional elastomers or resins.

7. The composition of claim 6, wherein the one or more additional elastomers or resins include a component selected from the group consisting of polyolefin elastomers, ethylene propylene diene monomer rubbers, and mixtures thereof.

8. The composition of claim 1 further comprising an oil, a filler, crosslinking additives, coagents, antioxidants, and/or residues thereof.

9. The composition of claim 8, wherein the coagents are selected from the group consisting of triallyl cyanurate, trimethyl, propane triacrylate, N,N-m-phenylene dimaleimide, m-phenylene dimaleimide, and combinations thereof.

10. The composition of claim 8, wherein the crosslinking additives include a component selected from the group consisting of water, a peroxide, boric acid, sulfonic acid, and combinations thereof.

11. The composition of claim 8, wherein the antioxidants are selected from the group consisting of phenols, organic phosphates, thioethers, and blends thereof.

12. The composition of claim 1, wherein the first polymer component is a silane grafted polyolefin.

13. The composition of claim 1, wherein the dispersed crosslinked phase is present in an amount of about 20 to 85 wt % and the continuous thermoplastic phase is present in an amount of about 80 to 15 wt % of the combined weight of the dispersed crosslinked phase and the continuous thermoplastic phase.

14. The composition of claim 1, wherein the dispersed crosslinked phase is present in an amount of about 30 to 70 wt % and the continuous thermoplastic phase is present in an amount of about 70 to 30 wt % of the combined weight of the dispersed crosslinked phase and the continuous thermoplastic phase.

15. A method for making a thermoplastic vulcanizate composition, the method comprising:
a) providing a first polymer component that includes a silane-grafted polyolefin;
b) providing a second polymer component selected from the group consisting of polypropylene resin, polypropylene copolymers, and combinations thereof,
c) combining the first polymer component, the second polymer component, and crosslinking additives to form a reactive mixture, the crosslinking agents including an inorganic hydrate as a source of water for crosslinking; and
d) heating the reactive mixture to form the thermoplastic vulcanizate composition, wherein a crosslinked phase including residues of the first polymer component is dispersed in a continuous thermoplastic phase including residues of the second polymer component.

16. The method of claim 15, wherein the first polymer component further includes one or more additional elastomers or resins.

17. The method of claim 16, wherein the one or more additional elastomers or resins include a component selected from the group consisting of polyolefin elastomers, ethylene propylene diene monomer rubbers, and mixtures thereof.

18. The method of claim 15, wherein the crosslinking additives include a component selected from the group consisting of water, a peroxide, a condensation catalyst, and combinations thereof.

19. The method of claim 18, wherein the condensation catalyst is bismuth carboxylate.

20. The method of claim 18, wherein the condensation catalyst is a hydrolytically stabilized bismuth carboxylate.

21. The method of claim 18, wherein the crosslinking additives include calcium sulfate dihydrate or calcium sulfate hemihydrate as a source of water for cross-linking.

22. The method of claim 18, wherein the condensation catalyst is boric acid, sulfonic acid, dioctyl tin dilaurate, or mixtures thereof.

23. The method of claim 15, wherein the reactive mixture further includes a component selected from the group consisting of an oil, a filler, coagents, antioxidants, and combinations thereof.

24. The method of claim 15, wherein the silane-grafted polyolefin is prepared by combining a base polyolefin, a silane composition, a catalyst, and a grafting initiator to form a grafting composition.

25. The method of claim 24, wherein the silane composition, includes a vinyl alkoxy silane having the following formula: 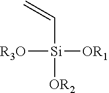
wherein R₁, R₂, and R₃ are each independently H or C₁₋₈ alkyl.

26. The method of claim 24 wherein the grafting composition is introduced into a twin screw extruder at a first feed location and reacted at a temperature above 180° C.

27. The method of claim 26 wherein the second polymer component is introduced into the twin screw extruder at a second feed location that is downstream of the first feed location.

28. The method of claim 26 wherein the silane-grafted polyolefin is formed in an extruder.

29. The method of claim 28 wherein steps b), c), and d) are performed in the extruder in which the silane-grafted polyolefin is formed.
